(19) United States
(12) Patent Application Publication
(10) Pub. No.: US 2007/0127952 A1
(43) Pub. Date: Jun. 7, 2007

(54) DEVELOPMENT DEVICE, PROCESS CARTRIDGE AND IMAGE FORMING APPARATUS

(76) Inventors: Mieko Terashima, Isehara-shi (JP); Tsuyoshi Imamura, Sagamihara-shi (JP); Kyohta Koetsuka, Fujisawa-shi (JP); Yoshiyuki Takano, Tokyo (JP); Noriyuki Kamiya, Yamato-shi (JP); Masayuki Ohsawa, Atsugi-shi (JP); Hiroya Abe, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/567,527

(22) Filed: Dec. 6, 2006

(30) Foreign Application Priority Data
Dec. 7, 2005 (JP) 2005-353664
May 29, 2006 (JP) 2006-148587

(51) Int. Cl. G03G 15/09

(52) U.S. Cl. 399/277

(57) ABSTRACT

A development device including a developer carrier including a cylindrical magnetic field-generation member having a surface portion provided with a plurality of magnetic poles and a rotatable hollow member which is disposed inside the magnetic field-generation member and formed of a non-magnetic material, a developer control member configured to control an amount of a developer which is carried on the developer carrier and fed to an image supporter disposed to office the developer carrier, and an agitator provided upstream the developer control member in a rotating direction of the developer carrier and configured to feed the developer contained in a developer-containing tank in an axial direction of the hollow member, a developer conveying pole being provided on the surface portion of the magnetic field-generation member to form a developer separation area for separating the developed developer which has thin toner density from the hollow member into the developer-containing tank on the surface portion of the hollow member, and only a developer pumping pole being provided downstream the developer conveying pole and between the developer control member and the agitator to pump the developer from the developer-containing tank.

### CROSS-REFERENCE TO THE RELATED APPLICATIONS

This application is based on and ins the priority benefit of each of Japanese Patent Application No. 2005-353664, filed on Dec. 7, 2005 and Japanese Patent Application No. 2006-148587, filed on May 29, 2006, the contents of which are incorporated herein by reference.

### BACKGROUND OF THE INVENTION

1. Field of the Invention

The present invention relates to a development device, a process cartridge and an image forming apparatus used in each of copying machines, facsimiles, printers or the like, more specifically, to a development device in which a developer carried on a development sleeve which is formed by a non-magnetic cylinder is fed to a development area of an image supporter disposed to face the development sleeve with an interval to develop a static latent image on the image supporter and form a toner image, a process cartridge including the development device and an image forming apparatus including the process cartridge.

2. Description of Related Art

A conventional development device includes a developer carrier disposed to face an image supporter and configured to feed a developer to a developed area of the image carrier to develop a static latent image formed on the image supporter and to form a toner image. The developer carrier has a cylindrical sleeve or development sleeve and a magnetic field-generation member, for example, a magnet roller which is disposed in the development sleeve and configured to form a magnetic field generating ears or raised portions of the developer on a surface of the development sleeve.

When the raised portions of developer are formed, a carrier constituting the developer rises on the development sleeve along a magnetic line generated by the magnet roller and charging toner is attached to the carrier. The magnet roller has a plurality of magnetic poles. A magnet forming each of the magnetic poles is formed by a bar-like member. In particular, provided on a portion of the magnet roller corresponding to a developing area provided on a surface of the development sleeve is a main development pole to raise the developer on the developing area.

The raised developer is moved in a circumferential direction of the development sleeve by rotating at least one of the development sleeve and the magnet roller.

Generally, to be easy to feed the developer, a surface of the development sleeve is adequately roughened by sandblast or the like. In particular, in a color copying machine or printer, roughening a surface of such a development sleeve predominates. A roughened process such as a grooved process, sandblast process or the like is provided on a surface of a developer carrier or a development sleeve used in an image forming apparatus of an electrophotographic system such as a copying machine, printer, facsimile or the like, except for a use of driving at a low speed. Such a roughened process such as the grooved process, the sandblast process or the like is formed to avoid low image density due to insufficient feeding of the developer occurred by slipping on the surface of the development sleeve rotating at a high speed. Such a development device is disclosed in, for example, Japanese Patent Laid-Open No. 11-162731.

FIG. 10 illustrates a conventional development device. The development device 200 includes a developer carrier 204 which feeds a developer 208 to a development area of an image supporter 211 facing the developer carrier 204 to develop a static latent image formed on a surface of the image supporter 211 and form a toner image. The developer carrier 204 has a cylindrical development sleeve 202 and a magnet roller 201 which is disposed in the development sleeve 202 and configured to form a magnetic field for generating ears or raised portions of the developer 208 on a surface of the development sleeve 202.

In the developer carrier 204, when the raised portions of the developer 208 are formed, a magnetic carrier constituting the developer 208 is raised on the development sleeve 202 along a magnetic line generated by the magnet roller 201 and toner constituting the developer 208 is attached to the raised carrier.

The development device 200 as shown in FIG. 10 includes a pair of developer-containing tanks 207 (207a and 207b) for containing the developer 208, a pair of agitators 206 (206a and 206b) each having, for example, a screw shape configured to agitate the developer 208 in each of the developer-containing tanks 207, and a developer control member 205 to form the developer 208 pumped on the developer carrier 204 to be in an uniform amount. The developer 208 in the development device 200 is moved in an axial direction of the agitator 206 in each of the developer-containing tanks 207.

The toner fed from one end portion of one developer-containing tan 207a remote from the developer carrier 204 is agitated with the developer 208 while being fed along the axial direction of one agitator 206a by the one agitator 206a to the other end portion of the one developer-containing tank 207a. Next, the developer 208 is moved from the other end portion of the one developer-containing tank 207a into the other developer-containing tank 207b near the developer carrier 204. The developer 208 moved into the other developer-containing tank 207b near the developer carrier 204 is pumped on a surface of the development sleeve 202 by a magnetic force of the magnet roller 201, in other words, attached on the surface of the development sleeve 202.

Thereafter, an amount of the developer 208 is uniformly adjusted by the developer control member 205, subsequently, transported to a development area of the image supporter 211 facing the developer carrier 204 with an interval. The developer 208 develops a static latent image formed on the image supporter 211 to a toner image.

A plurality of fixed magnetic poles, for example, a developer conveying pole n2, a developer pumping pole n2, a developer conveying pole s1, a developing pole n3, and a developer conveying pole 82 are provided on the magnet roller 201. Because the magnet roller 201 is rotated in a direction of arrow (g), the developer 208 is moved on the surface of the development sleeve 202 in order of the developer conveying pole n1, the developer pumping pole n2, the developer conveying pole s1, the developing pole n3 and the developer conveying pole s2.

In such a magnet roll 201, the developer conveying pole n1 and the developer pumping pole n2 are set to be the same N polar poles, if a magnetic pole (p) is provided between the developer conveying pole n1 and the developer pumping pole n1, the developed developer 208 which has low toner density is dropped in the developer-containing tank 207b by a force of repulsion of the magnetic pole (p) (corresponding to a magnetic pole P shown in FIG. 1) in addition to a force of repulsion of the developer conveying pole n1 and the developer pumping pole n2.

In the specification of the present application, the magnetic pole p (P) is referred to as a developer removing pole and an area (r) (corresponding to an area R shown in FIG. 1) where the developed developer 208 is dropped in the developer-containing tank 207b by the force of repulsion of the magnetic pole p (P) is referred to as a developer separation area. In this way, the developed developer 208 having the thin toner density which is dropped in the developer-containing tank 207b (or developer removal) is agitated in the developer-containing tank 207b with new developer having high toner density which has been fed from the developer-containing tank 207a, thereafter the developer 208 having the high toner density is attracted (pumped) to the developer pumping pole n2, then moved to the developer conveying pole s1.

The developer 208 having the high toner density which is moved to developer conveying pole s1 is set to be a certain amount by the developer control member 205 and moved to the developing pole n3.

In such a development device 200, because the developer pumping pole n2 to pump the developer from the developer-containing tank 207 and the developer conveying pole s1 are provided downstream the developer removing pole p in a direction of rotation of the developer carrier 204 and between the developer control member 205 and the agitator 206 in sequence, a changing pole point of the magnetic poles exists between the agitator 206 and the developer control member 205. In vicinity of the changing pole point of the magnetic poles, because a strong magnetic force is obtained, the developer 208 is strongly attracted to the development sleeve 202, therefore an amount of the developer 208 is too large, the developer 208 which is not fed by the development sleeve 202 is pooled so that developer reservoir is formed. Consequently, an amount of the developer used for development is lesser a developer casting amount, because the developer 208 has high frequency of use when used throughout a long period, there is a problem that the developer 208 is easy to deteriorate.

Moreover, when the developer 208 constituted by the carrier and the toner is used for a long period, because powder characteristic of the developer changes by embedding of additive agent in a surface of the carrier or fiction or the like of a surface film of the carriers an amount of the developer pumped by the development sleeve 202 is easy to change. In particular, because an amount of friction of the surface film of the carrier by the friction of development control member 205 is affected by distribution of a magnetic field of the developer carrier 204, in particular, of the developer pumping pole n2 and the developer conveying pole s1, the lowering of the amount of the developer 208 pumped on the development sleeve 202 is easy to occur, therefore there is a problem that an image formed on a surface of the image supporter 211 deteriorates with age.

In addition, in a development device in which cutting work or grinding process is provided on the development sleeve 202 to obtain high deflection accuracy, thereafter, sandblast process having a roughness of about 20μ is provided on the development sleeve so that concave and convex portions having fine pitches are formed on the surface of the development sleeve, because the developer 208 is in a state where it rides on the concave and convex portions of the development sleeve 202, the carrier is easy to slip on the development sleeve.

Moreover, in the development device including the concave and convex portions having the fie pitches, provided on the surface of the development sleeve 202, because each raised portion or ear of the developer 208 has a magnetic moment by the magnetic field from the magnet roller 201, if adjacent magnetic moments are in the same direction, the adjacent raised portions are reactive to maintain a certain interval, therefore elongate raised portions are formed. In addition, because the fine concave and convex portions which are formed on the surface of the development sleeve 202 are easy to wear when used for a long period, a pumped amount of the developer 208 is reduced.

Accordingly, in a development device in which cutting work or grinding process is provided on the conventional development sleeve 202 to obtain high deflection accuracy, thereafter, sandblast process having a roughness of about 10μ is provided on the development sleeve so that concave and convex portions having fine pitches are formed on the surface of the development sleeve, because developer conveying performance with age is reduced, there is a problem it is difficult to maintain high image quality throughout a long period in addition to the change of the developer 208 as mentioned above.

Furthermore, in the development sleeve 202 having a roughened surface of a groove shape, there is no problem such that the pumped amount of the developer 208 with age is reduced. However, because deflection occurs due to a stress when providing a groove process to form the roughened surface of the groove shape on the surface of the development sleeve 202, it is difficult to acquire accuracy higher than the sandblast process. After the groove process is provided on the surface of the development sleeve 202, it is considered that cutting work or grinding process is provided on the development sleeve 202. However, because burrs occur at the grooves when the cutting work or the like is provided, there are problems that failure of image occurs by removal of the burrs when used continuously, or conveying performance of developer 208 is reduced.

There is proposed a technology in which a plurality of ridge line-projections each having a polygonal shape are formed on a surface of a development sleeve and fine concave and convex portions are formed on portions other than the ridge line-projections, or a conductive resinous layer and a film such as a metallic processing layer are provided on the surface of the development sleeve, then fine concave and convex portions are provided on the surface of the development sleeve, to obtain a high accuracy and high durable developer carrier (for reference, see Japanese Patent Laid-Open No. 8-160736).

However, when the developer carrier to which the above-mentioned technology is applied is continuously used, because toner is adhered to the fine concave and convex portions formed on the surface of the development sleeve, there are problems that development ability is reduced or a working process becomes complication.

In the above-mentioned structure, a centrifugal force and a gravity force due to rotation of the development sleeve and a repulsive force due to the fixed poles n1-n2 are required to contain the developed developer in the developer-containing tank, but if the repulsive force is less or zero, the developed developer continues to be moved on the development sleeve without being contained in the developer-containing tank, that is to say “generation of traveling with developer”, the toner is not fed on the development sleeve, therefore there is a problem that irregularity such as mist occurs in an image.

### SUMMARY OF THE INVENTION

An object of the present invention is to provide a development device which is inexpensive and capable of preventing deterioration of a developer generated by embedding of ail additive agent into a surface of a carrier constituting the developer or wear of a surface film of the carrier by a developer control member, reduction of an amount of the developer pumped on a development sleeve generating with the deterioration of the developer, and traveling of the developed developer on the development sleeve, thereby obtaining high image quality without image deterioration.

To accomplish the above-mentioned object, a development device according to one embodiment of the present invention includes a developer carrier including a cylindrical magnetic field-generation member having a surface portion provided with a plurality of magnetic poles and a rotatable hollow member which is disposed inside the magnetic field-generation member and formed of a non-magnetic material, a developer control member configured to control an amount of a developer which is carried on the developer carrier and fed to an image supporter disposed to face the developer carrier, and an agitator provided upstream the developer control member in a rotating direction of the developer carrier and configured to feed the developer contained in a developer-containing tank in an axial direction of the hollow member.

A developer removing pole is provided on the surface portion of the magnetic field-generation member to form a developer separation area or separating the developed developer which has a thin toner condense from the hollow member into the developer-containing tank on the surface portion of the hollow member,

Only a developer pumping pole is provided downstream the developer removing pole and between the developer-control member and the agitator to pump the developer from the developer-containing tank.

### BRIEF DESCRIPTION OF THE DRAWINGS

FIG. 1 is an explanatory view showing a development device according to one embodiment of the present invention.

FIG. 2 is a graph showing a relationship between a magnetic distribution and a magnetic force distribution in a direction of normal line of a hollow member or development sleeve in a first embodiment and a first comparative example of the present invention.

FIG. 3 is a partially enlarged graph for explaining magnetic poles N1 and N2 in FIG. 2.

FIG. 4 is a graph for explaining magnetic force acting on a surface of the hollow member or the development sleeve in the first embodiment and the first comparative example of the present invention

FIG. 5 is a graph showing a relationship between a magnetic distribution and a magnetic force distribution in the direction of the normal line of the development sleeve in one embodiment of the present invention.

FIG. 6 is a graph showing the magnetic distribution and the magnetic force distribution shown in FIG. 2, with partially enlarged.

FIG. 7 is a schematic view showing a carrier in one embodiment of the present invention.

FIG. 8 is a schematic view showing a process cartridge in one embodiment of the present invention.

FIG. 9 is a schematic view showing an image forming apparatus in one embodiment of the present invention.

FIG. 10 is an explanatory view showing a conventional development device.

### DETAILED DESCRIPTION OF THE PREFERRED EMBODIMENTS

Preferred embodiments of the present invention will be explained in detail with reference to the accompanying drawings below.

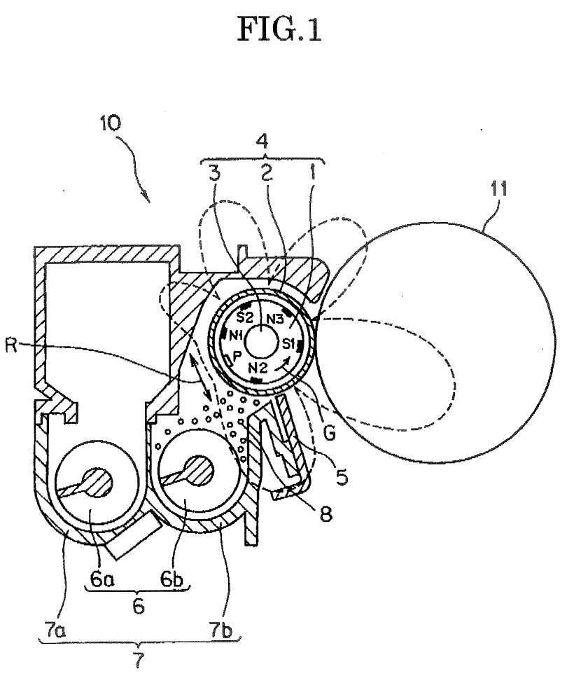

FIG. 1 illustrates one embodiment in which a development device 10 according to the present invention is applied to a copying machine or the like.

The development device 10 includes a developer carrier 4 which has a hollow member 2 and a magnetic field-generation member 1 disposed inside the hollow member 2. In the illustrated embodiment, the hollow member 2 is, for example, a development sleeve which is disposed to face an image supporter 11 used in a copying machine or the like and supplies a developer 8 to the image supporter 11, and the magnetic field-generation member 1 is, for example, a magnet roller which is cylindrically formed. The development sleeve 2 is formed to extend in an axial direction of the image supporter 11.

The magnet roller 1 is supported on a shaft 3, and the development sleeve 2 is rotatably supported about the shaft 3 by any mechanism (not shown).

The magnet roller 1 includes a surface portion with provided a plurality of fixed magnetic poles S1, S2, N1, N2 and N3. In other words, the plurality of fixed magnetic poles S1, S2, N1, N2 and N3 are provided about the magnet roller 1 with intervals circumferentially (see FIG. 1). These fixed magnetic poles are described hereinafter. The development sleeve 2 is made of a non-magnetic material.

The development device 10 further includes a developer control member 5 and an agitator 6. The developer control member 5 is configured to control an amount of the developer 8 which is carried on the developer carrier 4 and fed to the image supporter 11. The agitator 6 is formed, for example, by a screw shape and provided upstream the developer control member 5 in a direction of rotation of the developer carrier 4 to feed the developer 8 contained in a developer-containing tank 7 in an axial direction of the development sleeve 2.

In the development device 10, a developer removing pole P is provided on the surface portion of the magnet roller 1 to form a developer separation area R to drop the developed developer 8 having thin toner density from the development sleeve 2 into the developer-containing tank 7 on an outer surface of the development sleeve 2. The developer removing pole P is, for example, disposed between the fixed magnetic poles N1 and N2.

In the plurality of fixed magnetic poles provided on the magnet roller 1, for example, the fixed magnetic pole N1 is a developer conveying pole, the fixed magnetic pole N2 a developer pumping pole, the fixed magnetic pole S1 a developing pole, the fixed magnetic pole N3 a developer conveying pole, and the fixed magnetic pole S2 a developer conveying pole. Because the magnetic field-generation member 1 or magnet roller is rotated in a direction of arrow G, the developer 8 is transported on the surface of the development sleeve 2 in order of the developer conveying pole N1, the developer pumping pole N2, the developing pole S1, the developer conveying pole N3, and the developer conveying pole S2 in accordance with the rotation of the magnet roller 1.

The developer pumping pole N2 is disposed downstream the developer removing pole P in the rotating direction of the developer carrier 4 and configured to pump the developer 8 from the developer-containing tank 7 to an area between the developer control member 5 and the agitator 6. In the magnetic field-generation member or magnet roller 1, the developer conveying pole N1 and the developer pumping pole N2 are formed into the same N polarity, if the developer removing pole P having N polarity is provided between the developer conveying pole N1 and the developer pumping pole N2, the developed developer 8 having thin toner density is dropped into the developer-containing tank 7 by a repulsive force of the developer removing pole P in addition to repulsive forces of the developer conveying pole N1 and the developer pumping pole N2.

In this way, the developed developer 8 of the thin toner density, dropped in the developer-containing tank 7, in other words, separated from the development sleeve, is agitated in the developer-containing tank 7 with a new developer having thick toner density which has been fed from the developer-containing tank 7. Consequently, the developer of the thick toner density is attracted or pumped to the developer pumping pole N2. Next, an amount of the developer 8 having the thick toner density which is pumped by the developer pumping pole N2 is controlled constantly by the developer control member 5, and transported to the developing pole S1 to develop a latent image on the image supporter.

In this embodiment, the structure in which the development sleeve 2 is fixed and the magnet roller 1 is rotated in the direction of arrow G has been described, but a structure in which the magnet roller 1 is fixed and the development sleeve is rotated in the direction of arrow G may be adopted.

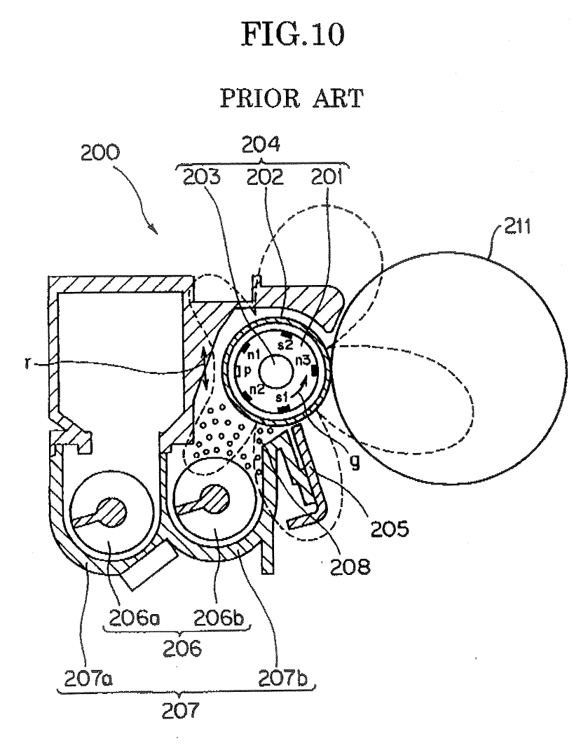

In this way, when the developer removing pole P is provided on the surface portion of the magnet roller 1 to form the developer separation area R for dropping the developed developer 8 having the thin toner density from the development sleeve 2 into the developer-containing tank 7 and only the developer pumping pole N2 configured to pump the developer from the developer-containing tank 7 is provided downstream the developer removing pole P in the rotating direction of the developer carrier 4 and between the developer control member 5 and the agitator 6, because there is no changing point of the magnetic poles between the agitator 6 and the developer control member 5, a developer reservoir (see FIG. 10) of the developer, which is formed between the agitator 206 and the developer control member 205 in the above-mentioned conventional development device 200 is not formed in this embodiment.

The developer in the developer reservoir cannot be pumped by the development sleeve 202.

Accordingly, because the developer 8 can be smoothly circulated so that the developer 8 is not attracted excessively, it is possible to provide a development device which is inexpensive and capable of preventing deterioration of the developer generated by embedding of an additive agent into a surface of a carrier constituting the developer or wear of a spice film of the carrier by the developer control member 5, reduction of an amount of the developer 8 pumped on a development sleeve 2 generating with the deterioration of the developer, and traveling of the developed developer on the development sleeve 2, thereby obtaining high image quality without image deterioration.

The developer removing pole P in this embodiment is formed by setting the developer pumping pole N2 and the developer conveying pole N1 which is disposed upstream and adjacent to the developer pumping pole and configured to form the developer separation area R in cooperation with the developer pumping pole to be the same pole. In this embodiment, for example, the developer pumping pole N2 and the developer conveying pole N1 are different poles each other.

The developer removing pole P is disposed between the developer conveying pole N1 and the developer pumping pole N2 and set to be the same pole as or different pole from the developer conveying pole N1 and the developer pumping pole N2 to allow the developer separation area R to form on the outer surface of the development sleeve 2 securely.

In this embodiment, at least one developer conveying pole which conveys the developed developer 8 to the developer-containing tank 7 is provided on the magnet roller 1 throughout an area from the developing pole S1 to the developer pumping pole N2. The developer separation area R is provided between the developer conveying pole N1 and the developer pumping pole N2. With such a structure, the developed developer 8 can be securely conveyed from the developing pole S1 to the developer separation area R. In addition, because the developer separation area R is formed by the developer pumping pole N2 and the developer conveying pole N1, it is not needed to provide an exclusively used magnetic pole to the developer separation area R, therefore it is possible to accomplish miniaturization of the magnet roller 1 and so on.

If the developer removing pole P is provided on the surface portion of the magnet roller 1 to form the developer separation area R for dropping the developed developer 8 having the thin toner density from the development sleeve 2 into the developer-containing tank 7 on the outer surface of the development sleeve 2, it is necessary to provide the developer removing pole P in such a manner that magnetic flux density of the developer removing pole is lower than the other magnetic poles, for example, an area having the magnetic flux density of 10 mT is provided throughout a width. For example, the developer conveying pole N1, the developer removing pole P and the developer pumping pole N2 are provided to have the same polarity, if the developer removing pole P having a low magnetic flux density is provided throughout a width, because a magnetic force at the developer removing pole P acts in a direction away from the surface of the development sleeve 2 by the repulsive force of the developer conveying pole N1 and the developer pumping pole N2, the developed developer drops from the surface of the development sleeve 2 into the developer-containing tank 7.

At the present time, if the change of the magnetic flux density at the changing portion from the developer conveying pole N1 to the developer removing pole P is fluent, for example, in case of the change of the magnetic flux density at the width of 1 degree, because the developer separation area P has a low area of the magnetic flux density, in other words, the developer separation area becomes narrow, the developer 8 is easy to travel on the development sleeve 2. Similarly, even when the change of a magnetic flux density at a changing portion from the developer removing pole P to the developer pumping pole N2 is fluent, the developer separation area P has a low area of the magnetic flux density, in other words, the developer separation area P becomes narrow. If the developed developer 8 travels on the development sleeve 2 and is not contained in the developer-containing tank 7, the toner is not fed to the traveled developer, and hence irregularity on an image occurs.

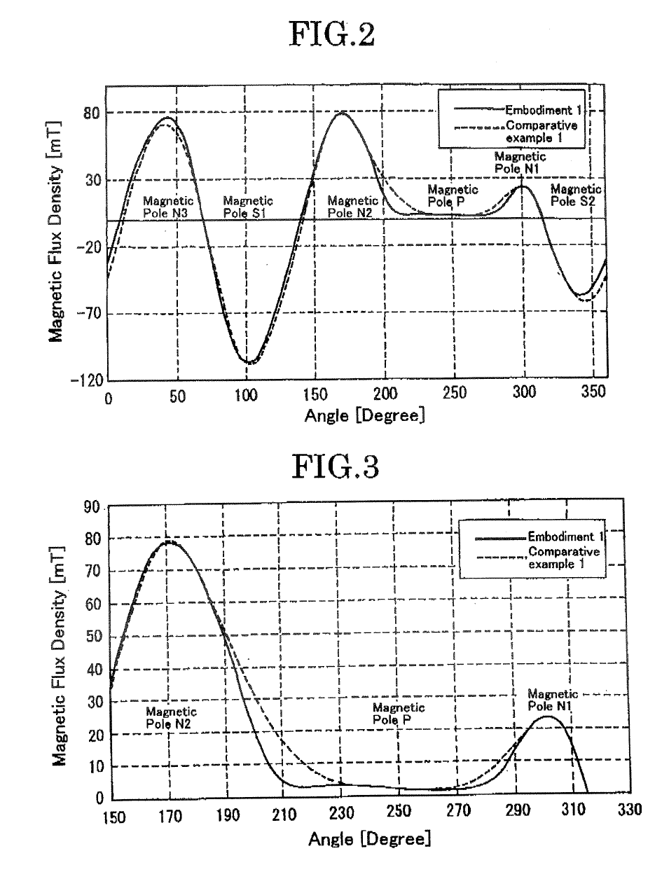

However, in this embodiment, as shown in FIGS. 2 and 3, the developer conveying pole N1 disposed upstream the developer removing pole P and the developer pumping pole N2 disposed downstream the developer removing pole P are provided so that the raising change of the magnetic flux density from both ends of the developer separation area R to the developer conveying pole N1 and the developer pumping pole N2 adjacent the developer removing pole P becomes rapidly large. In order to rapidly enlarge the raising change of the magnetic flux density from both ends of the developer separation area R to the developer conveying pole N1 and the developer pumping pole N2 adjacent the developer removing pole P with respect to the developer conveying pole N1 disposed upstream the developer removing pole P and the developer pumping pole N2 disposed downstream the developer removing pole P, the following processes are taken in the embodiment.

(1) Control of a magnetic field about the developer conveying pole N1, the developer removing pole P and the developer pumping pole N2 when magnetizing the magnet roller 1.

(2) Adjustment of mounted positions of magnet pieces of the developer conveying pole N1, the developer removing pole P and the developer pumping pole N2 on the magnet roller.

(3) Partial degauss of the magnetic flux density throughout the developer conveying pole N1 and the developer pumping pole N2 so that the raised portion of the magnetic flux density is slowly magnetized to allow the magnetic flux density to rapidly change.

It should be noted that the present invention is not limited to the above-mentioned processes.

In this way, when the raised change of the magnetic flux density from the developer removing pole P to the developer conveying pole N1 and the developer pumping pole N2 which are disposed adjacent the developer removing pole P is set to be rapidly large, because a wide range of magnetic force acting in a direction remote from the surface of the development sleeve 2 is obtained, the developer does not travel on the development sleeve 2, therefore it is possible to provide an inexpensive development device 10 capable of acquiring a high quality image without irregularity of image.

In this embodiment, a width of portion in which the magnetic flux density in an area from the developer conveying pole N1 and the developer pumping pole N2 to the developer removing pole P is 10 mT or less is preferably 75 degrees or more, as shown in FIG. 3. If the width of portion in which the magnetic flux density in the area from the developer conveying pole N1 and the developer pumping pole N2 to the developer removing pole P is 10 mT or less is less than 75 degrees, because an area where the developer separates becomes narrow, the developer is easy to travel on the development sleeve. In addition, because the developer which is separated once in an area from the developer conveying pole N1 to developer removing pole P is also easy to be attracted to the developer pumping pole N2, the developer is easy to travel on the development sleeve.

Accordingly, as in the present invention, if the width of portion in which the magnetic flux density in the area from the developer conveying pole N1 and the developer pumping pole N2 to the developer removing pole P is 10 mT or less is preferably 75 degrees or more, the developer 8 is easy to separate from the developer carrier 4, therefore the developed developer 8 does not travel on the development sleeve, thereby it is possible to acquire a stable improved image without generating irregularity in an image.

The developed developer 8 drops into the developer-containing tank 7 by the repulsive fore of the developer conveying pole N1 and the developer pumping pole N2, and the gravity force and the centrifugal force of the developer. However, if the position of the developer conveying pole N1 is too close to the developer pumping pole N2, because the developer separation area R becomes narrow, the developer is easy to travel on the development sleeve. On the contrary, if the position of the developer conveying pole N1 is too far away from the developer pumping pole N2, because the repulsive force becomes less, the developer 8 is difficult to separate from the surface of the development sleeve 2.

Furthermore, if the developer conveying pole N1 is too upstream from a horizontal position, the developer 8 which is separated once at a position from the developer conveying pole N1 to the developer removing pole P is easy to be attracted to the development sleeve 2 by the gravity force, and because the developer is kept on the development sleeve without feeding the toner to the image supporter, consequently the irregularity of the image occurs.

However, the position of the developer conveying pole N1 adjacent the upstream side of the developer removing pole P is preferably disposed in an upstream side at an angular range of 30 to 35 degrees to a horizontal direction. If the developer conveying pole N1 adjacent the upstream side of the developer removing pole P is disposed at an angle lesser than 30 degrees to the horizontal direction, because a strong centrifugal force acts in a gravity direction, even if the developer which begins to separate, the developer is easy to be attracted to the magnetic force of the developer pumping pole N2, and hence the developer is easy to travel on the development sleeve.

Accordingly, as shown in this embodiment, when the developer conveying pole N1 disposed upstream the developer removing pole P is positioned upstream at an angle of 30 to 35 degrees to the horizontal direction, the developed developer 8 is easy to separate in a far direction from the development sleeve 2 by the repulsive force of the developer conveying pole N1 and the developer pumping pole N2 adjacent the developer removing pole P, the gravity force and the centrifugal force, acting on the developed developer effectively. In this case, the developer which is separated once is attracted to the development sleeve 2 so that the developer does not travel on the development sleeve, whereby enabling obtaining a stable good image without irregularity of the image.

Because the removing of the developer 8 depends on the repulsive force of the developer conveying pole N1 and the developer pumping pole N2, as the magnetic flux density of the developer conveying pole N1 and the developer pumping pole N2 is high, the repulsive force is large to be easy to separate the developer. However, if the magnetic flux density of the developer conveying pole N1 is too high, the magnetic force of the surface of the development sleeve in the rotating direction from the developer conveying pole N1 through the developer removing pole P becomes also large. As a result, the developer is easy to move on the surface of the development sleeve 2.

However, the magnetic flux density of the developer conveying pole N1 disposed upstream the developer removing pole P is preferably 35 mT or less, as shown in FIG. 3. If the magnetic flux density of the developer conveying pole N1 disposed upstream the developer removing pole P exceeds 35 mT, the magnetic force of the development sleeve in the rotating direction from the developer conveying pole N1 through the developer removing pole P becomes large, the developer is easy to travel on the development sleeve 2 directly.

Consequently, if the magnetic flux density of the developer conveying pole N1 disposed upstream the developer removing pole P is 35 mT or less, the magnetic force of the developer carrier 4 in the rotating direction is relatively low, therefore the developer which travels on the developer carrier 4 is zero and contained in the developer-containing tank 7, thereby it is possible to obtain a stable good image having no irregularity of image.

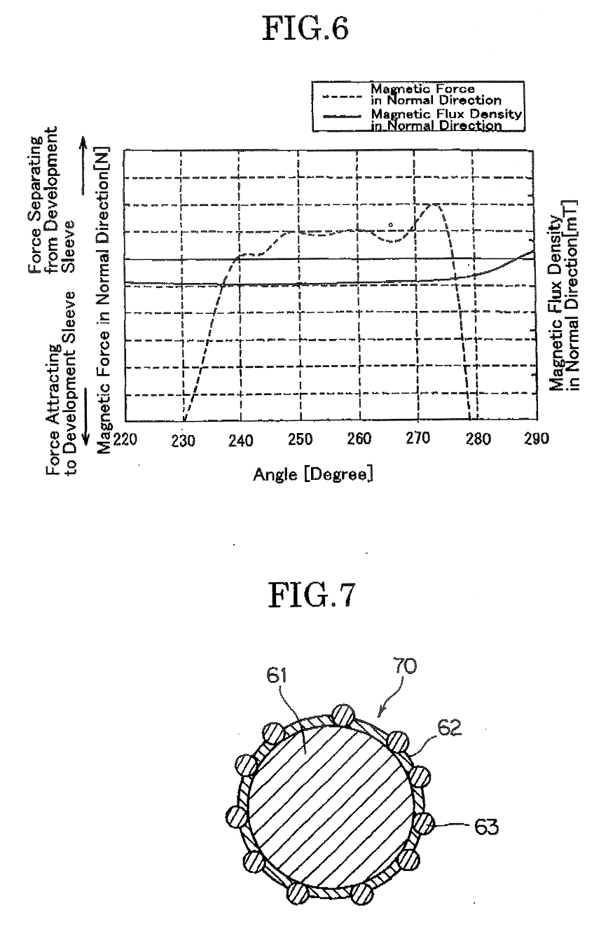

As shown in FIGS. 5 and 6, a direction of a magnetic force of the development sleeve 2 in a normal direction at the developer separation area R is selected to separate the developed developer 8 from the outer surface of the development sleeve 2. In this way, if the direction of the magnetic force of the development sleeve 2 in the normal direction at the developer separation area R is selected to separate the developed developer 8 from the outer surface of the development sleeve 2, the developer 8 does not travel on the development sleeve 2, therefore it is possible to provide a development device 10 capable of obtaining high image quality having no irregularity of image.

In the developer carrier in the development device according to the present invention, because the developer is attracted to the development sleeve 2 and transported while be g agitated by the agitator, it is import to control a magnetic force at this portion. If the magnetic force is too weak, because a small amount of developer is attracted, a thin image is formed and an uneven pitch of the agitator occurs. On the contrary, if the magnetic force is too strong, because a large amount of developer is attracted, the developer does not circulate smoothly so that the developer is easy to deteriorate.

A sum of magnetic forces from a developer removing initiation part in the developer separation area R to the developer control member 5 is preferably a range of 60 to 100 μN. If the sum of magnetic forces from the developer removing initiation part in the developer separation area R to the developer control member 5 is less than 60 μN, because a small amount of developer is attracted to the development sleeve at the developer control member 5, the thin image is formed, therefore the uneven pitch by the agitator occurs. If the sum of magnetic forces from the developer removing initiation part in the developer separation area R to the developer control member 5 exceeds 100 μN, because a large amount of developer is attracted to the development sleeve at the developer control member 5, a large amount of developer pass the developer control member 5, therefore the developer is easy to wear and deteriorate by a pressure between the developers or the developer and the developer control member.

Accordingly, as in the present invention, if the sum of magnetic forces from the developer removing initiation part in the developer separation area R to the developer control member 5 is a range of 60 μN to 100 μN, the uneven pitch of the developer control member 6 or the deterioration of the developer 8 can be prevented, therefore it is possible to provide a development device 10 capable of obtaining a high image quality.

In the development device 10, the development sleeve 2 preferably includes a surface having a plurality of randomly disposed elliptical depressions. The depressions are preferably formed by impacting particulate matters such as cut wires on the surface of the development sleeve, for example, by use of a conventional blast process. In this way, when the development sleeve 2 includes the surface having the plurality of randomly disposed elliptical depressions, the surface includes concave and convex portions having roughened pitches, therefore a thick raised portion or ear in which each concave portion has a base configured to prevent the developer from slipping. It has been confirmed that the concave portions do not wear easily, thereby it is possible to acquire a stable good image for a long period.

Generally, in a development device, image quality is significantly affected by a gap between a development sleeve and a photoconductive drum or image supporter, and a diameter of a magnetic carrier. If a gap between the development sleeve and the photoconductive drum is 0.1 mm to 0.4 mm, if the diameter of the magnetic carrier is 20 to 50μ, the best image quality can be obtained. If the gap between the development sleeve and the photoconductive drum is too small, an electric field between the development sleeve and the photoconductive drum is too strong, thereby the magnetic carrier moves to the photoconductive drum, failure referred to as carrier adhesion occurs.

On the contrary, if the gap between the development sleeve and the photoconductive drum is too large, because the electric field between the development sleeve and the photoconductive drum is small, large edge effect of the electric field at an edge of an image occurs, therefore it is difficult to obtain a uniform image.

If the diameter of the magnetic carrier is too small, because magnetization of the magnetic carrier is insufficient and hence the magnetic carrier is subjected to a less binding force from the development sleeve, the magnetic carrier results in the carrier adhesion. If the diameter of the magnetic carrier is too large, because a rough electric field occurs between the magnetic carrier and a latent image on the photoconductive drum, of course, a uniform image cannot be obtained.

As shown in FIG. 7, a particulate diameter of each of magnetic carriers 70 constituting the developer 8 is 20 to 50 μm. In this way, when the particulate diameter of each magnetic carrier constituting the developer 8 is 20 to 50 μm, it is possible to obtain a good image stable over time.

In addition, as shown in FIG. 7, the magnetic carrier 70 includes a core 61 made of a magnetic material and a resinous film 62 configured to cover a surface of the core, the resinous film 62 contains a resinous component which is formed by bridging acryl system resin and melamine resin and a charging adjuster.

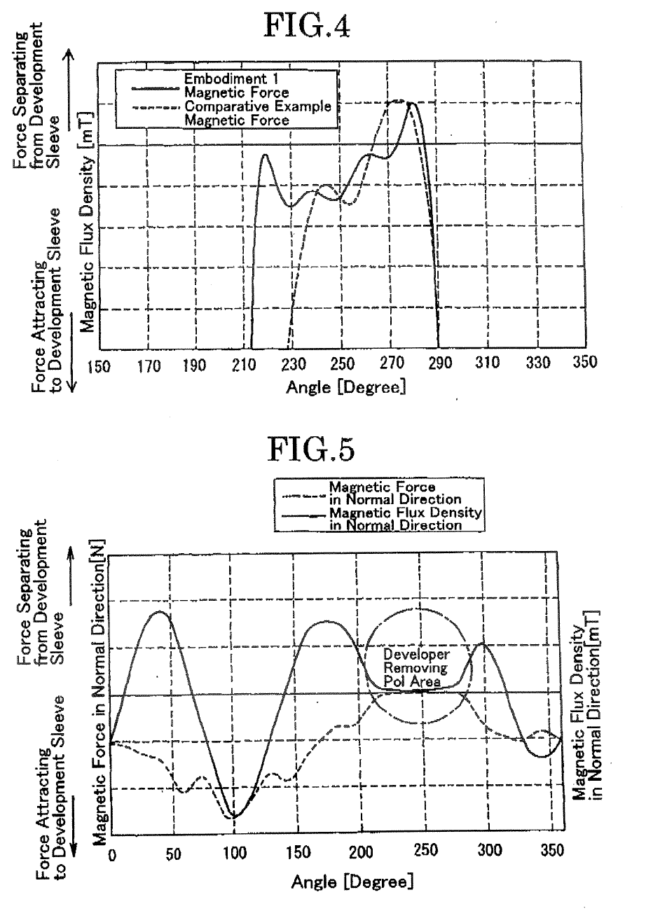

In FIG. 4, reference number 63 denotes large particles held by the resinous film 62 to absorb an impact or prevent breaking generated by collision between the magnetic carriers.

In this way, when the magnetic carrier 70 includes the core 61 made of the magnetic material and the resinous film 62 configured to cover the surface of the core, and the resinous film 62 contains the resinous component which is formed by bridging the acryl system resin and the melamine resin and the charging adjuster, the surface of the magnetic carrier 70 has more excellent abrasion resistance, therefore it is possible to provide the best image stable with age.

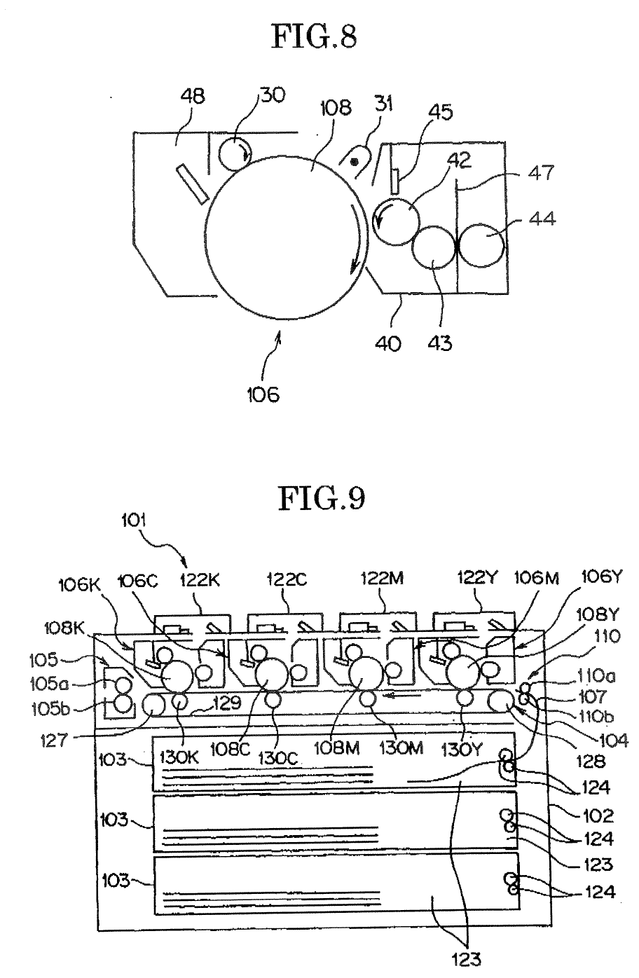

Referring to FIG. 8, a process cartridge 106 according to the present invention is shown. The process cartridge 106 includes a development device 40 having a developer carrier 42, developer supplying members 43 and 44 and a developer control member 45, an image supporter 108, and a charging roller 30. Here, reference numbers 31 and 47 show a remover of electricity and a partition, respectively.

Because the development device 40 having the above-mentioned structure is used, it is possible to a compact process cartridge which is inexpensive and capable of obtaining an improved image without irregularity.

Referring to FIG. 9, an image forming apparatus according to the present invention is shown. The image forming apparatus 101 includes a plurality of process cartridges 106Y, 106M, 106C and 106K, a plurality of photo writing units 122Y, 122M, 122C and 122K, a transfer unit 104 and a fixing unit 105. Each of the process cartridges 106Y, 106M, 106C and 106K is formed by the above-mentioned process cartridge 106. In this way, when the process cartridge 106 is applied to each of the process cartridges 106Y, 106M, 106C and 106K, it is possible to provide a compact image forming apparatus which is inexpensive and capable of obtaining an improved image without irregularity.

In the image forming apparatus 101, an image of each color such as yellow (Y), magenta (M), cyan (C), black (B), or color image is armed on a recording paper 107 as one transfer material. In FIG. 6, characters Y, M, C and K are attached to reference numbers of units or the like corresponding to colors of yellow, magenta, cyan and black.

The image forming apparatus 101 includes a main body 102 which has, for example, a box-like shape and is placed on a floor (not shown). The main body 102 is configured to contain a plurality of paper feeding units 103, a roller set 110 including a pair of resist rollers 110a and 110b, the transfer unit 104, the fixing unit 105, the plurality of photo writing units 122Y, 122M, 122C and 122K, the plurality of process cartridges 106Y, 106M, 106C and 106K.

In this embodiment, each of the plurality of photo writing units 122Y, 122M, 122C and 122K has a laser type. The paper feeding units 103 are disposed in a lower portion of the main body 102. Each of the paper feeding units 103 contains recording papers in a stacked state and includes a paper feeding cassette 123 capable of taking it in and out from the main body 102 and a paper feeding roller set 124.

The paper feeding roller set 124 feeds out the uppermost paper 107 to portions between a conveying belt 129 of the transfer unit, which is described hereinafter and each of image supporters 108Y, 108M, 108C and 108K disposed in the process cartridges 106Y, 106M, 106C and 106K. The roller set 110 is disposed in a conveying path of the recording paper 107 fed from each of the paper feeding units 103 to the transfer unit 104.

The roller set 110 is configured to sandwich the recording paper 107 between the pair of resist rollers 110a and 110b and feed out the sandwiched recording paper 107 toward between the transfer unit 104 and each of the process cartridges 106Y, 106M, 106C and 106K with a timing capable of overlapping toner images.

The transfer unit 104 is provided above the paper feeding units 103. The transfer unit 104 includes a drive roller 127, a driven roller 128, the conveying belt 129, and transfer rollers 130Y, 130M, 130C and 130K. The drive roller 127 is disposed downstream in a conveying direction of the recording paper 107 and driven by a drive source such as a motor. The driven roller 128 is rotatably mounted on the main body 102 and disposed upstream in the conveying direction of the recording paper 107. The conveying belt 129 is an endless type and is put about the drive roller 127 and the driven roller 128. The conveying belt 129 moves (endless moving) counterclockwise about the drive roller 127 and the driven roller 128 by driving the drive roller 127.

The transfer rollers 130Y, 130M, 130C and 130K are disposed to face the image supporters 108Y, 108M, 108C and 108K of the process cartridges 106Y, 106M, 106C and 106K, respectively, and configured to sandwich the recording paper 107 on the conveying belt 129 between each of the image supporters and each of the transfer rollers. In the transfer unit 104, each of the transfer rollers 130Y, 130M, 130C and 130K presses the recording paper 107 fed out of each of the paper feeding units 103 to each of the image supporters 108Y, 108M, 108C and 108K of the process cartridges 106Y, 106M, 106C and 106K to transfer a toner image on each image supporter on the recording paper 107. The transfer unit 104 is configured to feed out the recording paper 107 on which the toner image is transferred to the fixing device 105.

The fixing device 105 is provided upstream the transfer unit 104 in the conveying direction of the recording paper 107 and includes a pair of rollers 105a and 105b between which the recording paper 107 is sandwiched. The fixing unit 105 is configured to fix the toner image transferred from the each image supporter to the recording paper on the recording paper 107 by inserting the recording paper fed by the transfer unit between the rollers 105a and 105b and heating the recording paper 107.

Each of the photo writing units 122Y, 122K, 122C and 122K is mounted on an upper portion of the main body 102. The photo writing units 122Y, 122M, 122C and 122K correspond to the process cartridges 106Y, 106M, 106C and 106K, respectively. Each of the photo writing units 122Y, 122M, 122C and 122K forms the static latent image by irradiating with a laser light an outer surface of the image supporter 108 which is charged uniformly by the charging roller of each of the process cartridges 106Y, 106M, 106C and 106K respectively. Each of the process cartridges 106Y, 106M, 106C and 106K is provided between the transfer unit 104 and each of the photo writing units 122Y, 122M, 122C and 122K, respectively. Each of the process cartridges 106Y, 106M, 106C and 106K is detachably provided on the main body 102. Each of the process cartridges 106Y, 106M, 106C and 106K is provided in parallel to each other along a direction of conveying the recording paper 107.

### EMBODIMENT 1

After an magnetic compound which was comprised of a ferrite magnet and an EEA resin was molded by extrusion in a magnetic field to form a magnet tube of 16 mm in diameter, a cored bar of 6 mm in diameter was inserted into an hollow portion of the magnetic tube. The magnet tube in which the cored bar was inserted, was yoke-magnetized to allow only one pole of the magnetic poles to be positioned between an agitator of developer and a developer control member so that a magnet roller was formed. Then, after an aluminum tube was cut and processed to be 18 mm in outer diameter and 17 mm in inner diameter, large concave and convex portions were formed on a development sleeve by an electromagnetic blast performed with SUS cutting wires on an outer surface of the aluminum tube. The magnet roller was inserted in the development sleeve so that a developer carrier was obtained.

### COMPARATIVE EXAMPLE 1

After an magnetic compound which was comprised of a ferrite magnet and an EEA resin was molded by extrusion in a magnetic field to form a magnet tube of 16 mm in diameter, a cored bar of 6 mm in diameter was inserted into an hollow portion of the magnetic tube. The magnet tube in which the cored bar was inserted, was yoke-magnetized to allow two poles of the magnetic poles to be positioned between an agitator of developer and a developer control member so that a magnet roller was formed. Then, after an aluminum tube was cut and processed to be 18 mm in outer diameter and 17 mm inner diameter, a hundred of longitudinal grooves of 0.07 mm depth and 1.2 mm width were formed on a development sleeve. The magnet roller was inserted in the development sleeve so that a developer carrier was obtained.

### COMPARATIVE EXAMPLE 2

A developer carrier was obtained as in the case of the comparative example 1, except that a sandblast was performed on a circumferential surface of the aluminum tube which was cut and processed as mentioned above to form fine concave and convex portions.

### COMPARATIVE EXAMPLE 3

A developer carrier was obtained as in the case of the embodiment 1, except that the magnet tube in which the cored bar was inserted was yoke-magnetized to allow two poles of the magnetic poles to be positioned between the agitator of developer and the developer control member so that the magnet roller was formed.

### COMPARATIVE EXAMPLE 4

A developer carrier was obtained as in the case of the comparative example 1, except that the magnet tube in which the cored bar was inserted was yoke-magnetized to allow only one pole of the magnetic poles to be positioned between the agitator of developer and the developer control member so that the magnet roller was formed.

### COMPARATIVE EXAMPLE 5

A developer carrier was obtained in the case of the comparative example 1, except that after an magnetic compound which was comprised of a ferrite magnet and an EEA resin was molded by extrusion in a magnetic field to form a magnet tube of 16 mm in diameter, a cored bar of 6 mm in diameter was inserted into an hollow portion of the magnetic tube. The magnet tube in which the cored bar was inserted, was yoke-magnetized to allow only one pole of any magnetic poles to be positioned between the agitator of developer and the developer control member so that a magnet roller was formed. Then, after an aluminum tube was cut and processed to be 18 mm in outer diameter and 17 mm in inner diameter, fine concave and convex portions were formed by sandblasting on an outer surface of the aluminum tube to form a development sleeve.

Consequently, in the roller of the embodiment 1, an amount of the pumped up developer did not decrease so that good images could be obtained. On the other hand, in the comparative examples 1 to 3, the amount of the pumped up developer decreased because of a degradation of the developer in any surface types of the development sleeve. In the comparative example 4, an uneven image due to each pitch of the grooves on the surface of the development sleeve was provided. In the comparative example 5, the amount of the pumped up developer decreased because of the degradation of the surface of the development sleeve. The developer carriers obtained in the embodiment 1 and comparative examples 1 to 5 were installed in the image forming apparatus (IPSiO CX 400, Ricoh Co., Ltd.) and an evaluation of the images after 50 K sheets running was performed. The results of the evaluation of the images were obtained as shown in TABLE 1. An evaluation standard of the decrease of the amount of the pumped up developer in TABLE 1 means ‘very good’ for the amount of the pumped up developer which decreased less than 10%, ‘good’ for that which decreased 10% or more and less than 40%, and ‘bad’ for that which decreased 40% or more. In addition, an evaluation standard of an image quality means ‘very excellent’ (there is no problem in practical use), ‘excellent’ (there are certain problems in practical use), and ‘less’ (there are enough problems in practical use) by a sensitive test.

TABLE 1

| | Decrease of | |
|---|---|---|
| | Pumped Up | |
| | Developer | |
| | Amount | Image Quality |
| Embodiment 1 | Very Good | Very Excellent |
| Comparative Example 1 | Good | Less |
| Comparative Example 2 | Bad | Very Excellent |
| Comparative Example 3 | Good | Very Excellent |
| Comparative Example 4 | Very Good | Less |
| Comparative Example 5 | Good | Very Excellent |

### EMBODIMENT 2

After an magnetic compound which was comprised of a ferrite magnet and an EEA resin was molded by extrusion in a magnetic field to form a magnet tube of 16 mm in diameter, a cored bar of 6 mm in diameter was inserted into an hollow portion of the magnetic tube. The magnet tube in which the cored bar was inserted, was yoke-magnetized to allow only one pole of the magnetic poles to be positioned between the agitator of developer and the developer control member so that a magnet roller, where a sum of magnetic forces from a developer removing portion to the developer control member was 60 μN, was formed. Then, after an aluminum tube was cut and processed to be 18 mm in outer diameter and 17 mm in inner diameter, large concave and convex portions were formed on a development sleeve by an electromagnetic blast performed with SUS cutting wires on an outer surface of the aluminum tube. The magnet roller was inserted in the development sleeve so that a developer carrier was obtained.

### EMBODIMENT 3

A developer carrier was obtained as in the case of the embodiment 1, except that the magnet tube in which the cored bar was inserted was yoke-magnetized to allow only one pole of the magnetic poles to be positioned between the agitator of developer and the developer control member, so that the magnet roller, where a sum of a magnetic forces between the developer removing portion and the developer control member was 100 μN, was formed

### COMPARATIVE EXAMPLE 6

A developer carrier was obtained as in the case of the embodiment 1, except that the magnet tube in which the cored bar was inserted was yoke-magnetized to allow only one pole of the magnetic poles to be positioned between the agitator of developer and the developer control member, so that the magnet roller, where a sum of a magnetic forces between the developer removing portion and the developer control member was 51 μN, was formed

### COMPARATIVE EXAMPLE 7

A developer carrier was obtained as m the case of the embodiment 1, except that the magnet tube in which the cored bar was inserted was yoke-magnetized to allow only one pole of the magnetic poles to be positioned between the agitator of developer and the developer control member, so that the magnet roller, where a sum of a magnetic forces between the developer removing portion and the developer control member was 59 μN, was formed.

### COMPARATIVE EXAMPLE 8

A developer carrier was obtained as in the case of the embodiment 1, except that the magnet tube in which the cored bar was inserted was yoke-magnetized to allow only one pole of the magnetic poles to be positioned between the agitator of developer and the developer control member, so that the magnet roller, where a sum of a magnetic forces between the developer removing portion and the developer control member was 101 μN, was formed.

### COMPARATIVE EXAMPLE 9

A developer carrier was obtained as in the case of the embodiment 1, except that the magnet tube in which the cored bar was inserted was yoke-magnetized to allow only one pole of the magnetic poles to be positioned between the agitator of developer and the developer control member, so that the magnet roller, where a sum of a magnetic forces between the developer removing portion and the developer control member was 110 μN, was formed

Consequently, in the embodiments 2 and 3 and also subsequent follow-up survey, the amount of the pumped up developer did not almost changed and god images could be stably obtained. However, in the comparative examples 6 and 7, although a decreasing level of the amount of the pumped up developer was good, the uneven image due to a pitch of the agitator was provided. In addition, in the comparative examples 8 and 9, the amount of the pumped up developer decreased about 12˜15%, and the image was inferior in quality. The developer carriers obtained in the embodiments 2, 3 and the comparative examples 6 to 9 were installed in the image forming apparatus (IPSiO CX 400, Ricoh Co., Ltd.) and an evaluation of the images after 50 K sheets running was performed. The results of the evaluation of the images were obtained as shown in TABLE 2. An evaluation standard of the decrease of the amount of the pumped up developer in TABLE 2 means ‘very good’ for the amount of the pumped up developer which decreased less than 10%, ‘good’ for that which decreased 10% or more and less than 40%, and ‘bad’ for that which decreased 40% or more. In addition, an evaluation standard of an image quality means ‘very excellent’ (there is no problem in practical use), ‘excellent’ (there are certain problems in practical use), and ‘less’ (there are enough problems in practical use) by a sensitive test.

TABLE 2

| | Decrease of | |
|---|---|---|
| | Pumped Up | |
| | Developer | |
| | Amount | Image Quality |
| Embodiment 2 | Very Good | Very Excellent |
| Embodiment 3 | Very Good | Very Excellent |
| Comparative Example 6 | Very Good | Excellent |
| Comparative Example 7 | Very Good | Excellent |
| Comparative Example 8 | Good | Very Excellent |
| Comparative Example 9 | Good | Excellent |

### EMBODIMENT 4

After an magnetic compound which was comprised of a ferrite magnet and an EEA resin was molded by extrusion in a magnetic field to form a magnet tube of 16 mm in diameter, a cored bar of 6 mm in diameter was inserted into an hollow portion of the magnetic tube. The magnet tube in which the cored bar was inserted, was yoke-magnetized to allow only one pole of the magnetic poles to be positioned between an agitator of developer and a developer control member, and to allow a changing portion of the magnetic poles adjacent to both adjacent sides of a developer separation area to change largely so that a magnet roller was formed. Magnetic properties of the magnet roller are shown in FIGS. 2 and 3. Then, after an aluminum tube was cut and processed to be 18 mm in outer diameter and 17 mm in inner diameter, large concave and convex portions were formed on a development sleeve by an electromagnetic blast performed with SUS cutting wires on an outer surface of the aluminum tube. The magnet roller was inserted in the development sleeve so that a developer carrier was obtained.

### COMPARATIVE EXAMPLE 10

After an magnetic compound which was comprised of a ferrite magnet and an EEA resin was molded by extrusion in a magnetic field to form a magnet tube of 16 mm in diameter, a cored bar of 6 mm in diameter was inserted into an hollow portion of the magnetic tube. The magnet tube in which the cored bar was inserted, was yoke-magnetized to allow only one pole of the magnetic poles to be positioned between an agitator of developer and a developer control member, and to allow a changing portion of the magnetic poles adjacent to both adjacent sides of a developer separation area to change gradually so that a magnet roller was formed. Magnetic properties of the magnet roller are shown in FIGS. 2 and 3. Then, after an aluminum tube was cut and processed to be 18 mm in outer diameter and 17 mm in inner diameter, large concave and convex portions were formed on a development sleeve by an electromagnetic blast performed with SUS cutting wires on an outer surface of the aluminum tube. The magnet roller was inserted in the development sleeve so that a developer carrier was obtained.

As mentioned above, an intensity of the magnetic field was calculated from magnetic flux densities in a normal direction and a tangential direction of the developer carrier obtained in each of the embodiment 4 and the comparative example 10 to calculate magnetic forces at each points. Properties were obtained as shown in FIG. 4. Although in the developer carrier obtained in each of the embodiment 4 and the comparative example 10, a peak magnetic flux density of a fixed magnetic pole N1 was positioned at a substantially same position as that of a fixed magnetic pole N2, a distribution of the magnetic flux density of the fixed magnetic pole N1 or N2 differed from that of a developer removing pole P. It could be found that the magnetic force in the comparative example 10, whose gradient was small, allows the developer to be removed from the development sleeve in a smaller area than that in the embodiment 4, whose gradient was large. In addition, the developer carrier obtained in each of the embodiment 4 and the comparative example 10 was installed in the image form apparatus and the developer of 155 g was put to verify a behavior of the developer. The developer did not travel on the development carrier of the embodiment 1, on the other hand, the developer of about 7% traveled on that of the comparative example 1.

### EMBODIMENT 5

After an magnetic compound which was comprised of a ferrite magnet and an EEA resin was molded by extrusion in a magnetic field to form a magnet tube of 16 mm in diameter, a cored bar of 6 mm in diameter was inserted into an hollow portion of the magnetic tube. The magnet tube in which the cored bar was inserted, was yoke-magnetized to allow only one pole of the magnetic poles to be positioned between an agitator of developer and a developer control member, and to allow an angle where the magnetic flux density was 10 mT or less in the developer separation area to be 75 degrees so that a magnet roller was formed. Then, after an aluminum tube was cut and processed to be 18 mm in outer diameter and 17 mm in inner diameter, large concave and convex portions were formed on a development sleeve by an electromagnetic blast performed with SUS cutting wires on an outer surface of the aluminum tube. The magnet roller was inserted in the development sleeve so that a developer carrier was obtained.

### EMBODIMENT 6

After the magnet tube was formed and the cored bar was inserted therein as in the case of the embodiment 5, the magnet tube was yoke-magnetized to allow an angle where the magnetic flux density was 10 mT or less in the developer separation area to be 82 degrees so that a magnet roller was formed. The magnet roller was inserted in the development sleeve so that a developer carrier was obtained as in the case of the embodiment 5.

### COMPARATIVE EXAMPLE 11

After an magnetic compound which was comprised of a ferrite magnet and an EEA resin was molded by extrusion in a magnetic field to form a magnet tube of 16 mm diameter, a cored bar of 6 mm in diameter was inserted into an hollow portion of the magnetic tube. The magnet tube in which the cored bar was inserted, was yoke-magnetized to allow only one pole of the magnetic poles to be positioned between an agitator of developer and a developer control member, and to allow an angle where the magnetic flux density was 10 mT or less in the developer separation area to be 74 degrees so that a magnet roller was formed. Then, after an aluminum tube was cut and processed to be 18 mm in outer diameter and 17 mm in inner diameter, large concave and convex portions were formed on a development sleeve by an electromagnetic blast performed with SUS cutting wires on an outer surface of the aluminum tube. The magnet roller was inserted in the development sleeve so that a developer carrier was obtained.

As mentioned above, the developer carrier obtained in each of the embodiments 5, 6 and the comparative example 11 was installed in the image forming apparatus and the developer of 155 g was put to verify a behavior of the developer. The developer did not substantially travel on the development carrier of each of the embodiments 5 and 6, on the other hand, the developer of about 3% traveled on that of the comparative example 11. In addition, an image evaluation was performed by verifying whether or not an imbricate uneven image was provided for 10 solid images (all in one color) by using the image forming apparatus (IPSiO CX 400, Ricoh Co., Ltd.). Results of the image evaluation were obtained as shown in TABLE.3. The evaluation of imbricate images in TABLE.3 is a ten-grade (from 0 to 5, every 0.5) and visual evaluation, and the evaluation standard is as follows;

Very Good: rank 4.5 or more (imbricate uneven images are substantially not found, that is to say, good images are obtained)

Good: rank 3.5 or more, less than 4.5 (imbricate uneven images are found, but there is no problem in practical use).

Bad: rank 3 or less (many imbricate uneven images are found, and there are enough problems in practical use)

TABLE 3

| | Imbricate Uneven Rank | Evaluation |
|---|---|---|
| Embodiment 5 | 4.5 | Very Good |
| Embodiment 6 | 3.5 | Good |
| Comparative | 3 | Bad |
| Example 11 | | |

### EMBODIMENT 7

After an magnetic compound which was comprised of a ferrite magnet and an EEA resin was molded by extrusion in a magnetic field to form a magnet tube of 16 mm in diameter, a cored bar of 6 mm in diameter was inserted into an hollow portion of the magnetic tube. The magnet tube in which the cored bar was inserted, was yoke-magnetized to allow only one pole of the magnetic poles to be positioned between an agitator of developer and a developer control member, and to allow a half-value central angle of the fixed magnetic pole N1, which is positioned upstream with relation to a rotation direction of the magnet roller in the developer separation area, to be 30 degrees to a horizontal direction when the magnet roller was disposed in the development apparatus so that a magnet roller was formed. Here, the half-value central angle means an angle of a central position of angles where each of magnetic flux densities was half of the peak magnetic flux density. Then, after an aluminum tube was cut and processed to be 18 mm in outer diameter and 17 mm in inner diameter, large concave and convex portions were formed on a development sleeve by an electromagnetic blast performed with SUS cutting wires on an outer surface of the aluminum tube. The magnet roller was inserted in the development sleeve so that a developer carrier was obtained.

### EMBODIMENT 8

The magnet tube which was formed and had the cored bar inserted therein as in the case of the embodiment 7, was yoke-magnetized to allow the half-value central angle of the fixed magnetic pole N1 to be 33 degrees to the horizontal direction so that a magnet roller was formed. The magnet roller was inserted in the development sleeve so that a developer carrier was obtained as in the case of the embodiment 7.

### EMBODIMENT 9

The magnet tube which was formed and had the cored bar inserted therein as in the case of the embodiment 7, was yoke-magnetized to allow the half-value central angle of the fixed magnetic pole N1 to be 35 degrees to the horizontal direction so that a magnet roller was formed. The magnet roller was inserted in the development sleeve so that a developer carrier was obtained as in the case of the embodiment 7.

### COMPARATIVE EXAMPLE 12

The magnet tube which was formed and had the cored bar inserted therein as in the case of the embodiment 7, was yoke-magnetized to allow the half-value central angle of the fixed magnetic pole N1 to be 29 degrees to the horizontal direction so that a magnet roller was formed. The magnet roller was inserted in the development sleeve so that a developer carrier was obtained as in the case of the embodiment 7.

### COMPARATIVE EXAMPLE 13

The magnet tube which was formed and had the cored bar inserted therein as in the case of the embodiment 7, was yoke-magnetized to allow the half-value central angle of the fixed magnetic pole N1 to be 36 degrees to the horizontal direction so that a magnet roller was formed. The magnet roller was inserted in the development sleeve so that a developer carrier was obtained as in the case of the embodiment 7.

As mentioned above, the developer carrier obtained in each of the embodiments 7 to 9 and the comparative examples 12, 13 was installed in the image forming apparatus (IPSiO CX 400, Ricoh Co., Ltd.). An image evaluation was performed by verifying whether or not an imbricate uneven image was provided for 10 solid images (all in one color). Results of the image evaluation were obtained as shown in TABLE.4. The evaluation of imbricate images in TABLE.4 is a ten-grade (from 0 to 5, every 0.5) and visual evaluation, and the evaluation standard is as follows;

Very Good: rank 4.5 or more (imbricate uneven images are substantially not found, that is to say, good images are obtained)

Good: rank 3.5 or more, less than 4.5 (imbricate uneven images are found, but there is no problem in practical use).

Bad: rank 3 or less (many imbricate uneven images are found, and there are enough problems in practical use)

TABLE 4

| | Imbricate | |
|---|---|---|
| | Uneven Rank | Evaluation |
| Embodiment 7 | 3.5 | Good |
| Embodiment 8 | 4.5 | Very Good |
| Embodiment 9 | 3.5 | Good |
| Comparative Example 12 | 3 | Bad |
| Comparative Example 13 | 3 | Bad |

### EMBODIMENT 10

After an magnetic compound which was comprised of a ferrite magnet and an EEA resin was molded by extrusion in a magnetic field to form a magnet tube of 16 mm in diameter, a cored bar of 6 mm in diameter was inserted into an hollow portion of the magnetic tube. The magnetic tube in which the cored bar was inserted, was yoke-magnetized to allow only one pole of the magnetic poles to be positioned between an agitator of developer and a developer control member, and to allow a peak magnetic flux density of the fixed magnetic pole N1, which is positioned upstream with relation to a rotation direction of the magnet roller in the developer separation area, to be 35 mT. Then, after an aluminum tube was cut and processed to be 18 mm in outer diameter and 17 mm in inner diameter, large concave and convex portions were formed on a development sleeve by an electromagnetic blast performed with SUS cutting wires on an outer surface of the aluminum tube. The magnet roller was inserted in the development sleeve so that a developer carrier was obtained.

### EMBODIMENT 11

The magnet tube which was formed and had the cored bar inserted therein as in the case of the embodiment 10, was yoke-magnetized to allow the peak magnetic flux density of the fixed magnetic pole N1 to be 31 mT so that a magnet roller was formed. The magnet roller was inserted in the development sleeve so that a developer carrier was obtained as in the case of the embodiment 7.

### COMPARATIVE EXAMPLE 14

The magnet tube which was formed and had the cored bar inserted therein as in the case of the embodiment 10, was yoke-magnetized to allow the peak magnetic flux density of the fixed magnetic pole N1 to be 36 mT so that a magnet roller was formed. The magnet roller was inserted in the development sleeve so that a developer carrier was obtained as in the case of the embodiment 10.

As mentioned above, the developer carrier obtained in each of the embodiments 10, 11 and the comparative example 14 was installed in the image forming apparatus (IPSiO CX 400, Ricoh Co., Ltd.). An image evaluation was performed by verifying whether or not an imbricate uneven image was provided for 10 solid images (all in one color). Results of the image evaluation were obtained as shown in TABLE.5. The evaluation of imbricate images in TABLE 5 is a ten-grade (from 0 to 5, every 0.5) and visual evaluation, and the evaluation standard is as follows;

Very God: rank 4.5 or more (imbricate uneven images are substantially not found, that is to says good images are obtained)

Good: rank 3.5 or more, less than 4.5 (imbricate uneven images are found, but there is no problem in practical use).

Bad: rank 3 or less (many imbricate uneven images are found, and there are enough problems in practical use)

TABLE 5

| | Imbricate Uneven Rank | Evaluation |
|---|---|---|
| Embodiment 10 | 3.5 | Good |
| Embodiment 11 | 4.5 | Very Good |
| Comparative | 3 | Bad |
| Example 14 | | |

Although the preferred embodiments of the present invention have been mentioned, the present invention is not limited to these embodiments, various modifications and changes can be made to the embodiments.

What is claimed is:

1. A development device comprising:
a developer carrier including a cylindrical magnetic field-generation member having a surface portion provided with a plurality of magnetic poles and a rotatable hollow member which is disposed inside the magnetic field-generation member and formed by a non-magnetic material;
a developer control member configured to control an amount of a developer which is carried on the developer carrier and fed to an image supporter disposed to face the developer carrier; and
an agitator provided upstream the developer control member in a rotating direction of the developer carrier and configured to feed the developer contained in a developer-containing tank in an axial direction of the hollow member,
wherein a developer removing pole is provided on the surface portion of the magnetic field-generation member to form a developer separation area for dropping developed developer which has thin toner density from the hollow member into the developer-containing tank on the surface portion of the hollow member,
wherein only a developer pumping pole which is provided downstream the developer removing pole and between the developer control member and the agitator and configured to pump the developer from the developer-containing tank.

2. The development device according to claim 1,
wherein a developer conveying pole is provided upstream and adjacent the developer pumping pole and configured to form the developer separation area in cooperation with the developer pumping pole,
wherein the developer removing pole is formed by setting so that the developer pumping pole and the developer conveying pole have the same polarity,
wherein the developer removing pole has a polarity similar to or different from the developer pumping pole and the developer conveying pole.

3. The development device according to claim 1,
wherein a developer conveying pole is provided upstream and adjacent the developer pumping pole and configured to form the developer separation area in cooperation with the developer pumping pole,
wherein the developer removing pole is formed by setting so that the developer pumping pole and the developer conveying pole have the same polarity,
wherein the developer removing pole is disposed between the developer pumping pole and the developer conveying pole and has a polarity similar to or different from the developer pumping pole and the developer conveying pole.

4. The development device according to claim 1,
wherein at least one developer conveying pole for conveying the developed developer to the developer-containing tank is provided on the magnetic field-generation member in a position from a developing pole to the developer pumping pole,
wherein the developer separation area is provided in a position from a developer conveying pole close to the developer pumping pole to the developer pumping pole.

5. The development device according to claim 1,
wherein a developer conveying pole is disposed upstream and adjacent the developer removing pole,
wherein developer conveying pole and the developer pumping pole disposed downstream the developer removing pole are provided so that the raising change of the magnetic flux density from both ends of the developer separation area to the developer conveying pole and the developer pumping pole adjacent the developer removing pole becomes rapidly large.

6. The development device according to claim 1,
further comprising a developer conveying pole disposed upstream and adjacent the developer removing pole,
wherein a width in an area where magnetic flux density in an area from the developer conveying pole and the developer pumping pole adjacent the developer removing pole to the developer removing pole is 10 mT or less is 75 degrees or more.

7. The development device according to claim 1,
wherein a developer conveying pole is disposed upstream and adjacent the developer removing pole,
wherein a position of the developer conveying pole is disposed in an upstream side of the developer removing pole at 30 to 35 degrees to a horizontal direction.

8. The development device according to claim 1,
further comprising a developer conveying pole upstream and adjacent the developer removing pole,
wherein magnetic flux density of the developer conveying pole is 35 mT or less.

9. The development device according to claim 1,
wherein a direction of a magnetic force of the hollow member in a direction of normal line at the developer separation area is selected in a direction separating the developed developer from an outer surface of the hollow member.

10. The development device according to claim 1,
wherein a sum of magnetic forces from a developer separation initiation part to the developer control member is 60 to 100 μN.

11. The development device according to claim 1,
wherein the hollow member includes a surface having a plurality of randomly disposed depressions.

12. The development device according to claim 1,
wherein a particulate diameter of a magnetic carrier constituting the developer is 20 to 50 μm.

13. The development device according to claim 12,
wherein the magnetic carrier includes a core made of a magnetic material and a resinous film configured to cover a surface of the core,
wherein the resinous film includes a resinous component formed by bridging acryl system resin and melamine resin and a charging adjuster.

14. A process cartridge comprising:
a development device including a developer carrier, a developer supplying member and a developer control member;
an image supporter; and
a charging roller,
the development device being formed by the development device as recited in claim 1.

15. An image forming apparatus comprising:
a process cartridge;
a photo writing device;
a transfer member; and
a fix device,
wherein the process cartridge comprises the process cartridge as recited in claim 14.
